(19) United States
(12) Patent Application Publication
(10) Pub. No.: US 2011/0209893 A1
(43) Pub. Date: Sep. 1, 2011

(54) CABLE STRUCTURE

(76) Inventors: Chun-Chieh Yu, Tu-Cheng City (TW); Ming-Xing Jiang, Dong-Guan (CN)

(21) Appl. No.: 12/714,287

(22) Filed: Feb. 26, 2010

(51) Int. Cl. H01B 7/18

(52) U.S. Cl. 174/107

(57) ABSTRACT

A cable structure includes a conductor, a shielding layer wrapped the conductor, a knit layer surrounding the shielding layer, and an insulating layer bound round the knit layer. The knit layer is interlaced by multiple knitting wires. Each of the knitting wires has a plurality of metallic wires which are arranged side by side to form a metallic strip, and at least one fiber filament arranged at an outer side of the metallic strip. The abreast knitting wires are arranged by means of each two adjacent metallic strips sandwiching at least one fiber filament therebetween.

### BACKGROUND OF THE INVENTION

1. Field of the Invention

The present invention relates to a cable structure, and particularly to a cable structure capable of improving the bending endurance and the twisting endurance.

2. The Related Art

Cables are mainly used to connect between two electronic devices for electric and optical transmission. A conventional cable structure is generally involved with a conducting wire, a shielding layer wrapped to the conducting wire, a knit layer surrounding the shielding layer, and an insulating layer bound round the knit layer. Herein, the knit layer is usually knitted from multiple metallic wires, such as tin-plated copper wires or multiple copper-plated aluminum wires. However, since the cable is constantly bent and twisted in use, the metallic wires made up of the knit layer are apt to generate strong extrusion and friction mutually, which fatigues the bending endurance and the twisting endurance of the metallic wires. As a result, the metallic wires of the knit layer are easy to break and unable to use after a long time use.

### SUMMARY OF THE INVENTION

Accordingly, an object of the present invention is to provide a cable structure capable of improving the bending endurance and the twisting endurance. The cable structure includes a conductor, a shielding layer wrapped the conductor, a knit layer surrounding the shielding layer, and an insulating layer bound round the knit layer. The knit layer is interlaced by multiple knitting wires. Each of the knitting wires has a plurality of metallic wires which are arranged side by side to form a metallic strip, and at least one fiber filament arranged at an outer side of the metallic strip. The abreast knitting wires are arranged by means of each two adjacent metallic strips sandwiching at least one fiber filament therebetween.

As described above, each of the knitting wires has the fiber filament which is capable of reducing the extrusion and friction between the two adjacent metallic strips when the cable structure is bent or twisted. Therefore, the knit layer is able to bear the repeated bend and twist, correspondingly, elongating the use lifetime of the cable.

### BRIEF DESCRIPTION OF THE DRAWINGS

The present invention will be apparent to those skilled in the art by reading the following description thereof, with reference to the attached drawings, in which:

FIG. 1 is a cross-sectional view of a cable structure of an embodiment in accordance with the present invention; and

FIG. 2 is a partially plan view of a knit layer of the cable structure shown in FIG. 1.

### DETAILED DESCRIPTION OF THE EMBODIMENT

Reference will now be made to the drawing figures to describe the present invention in detail.

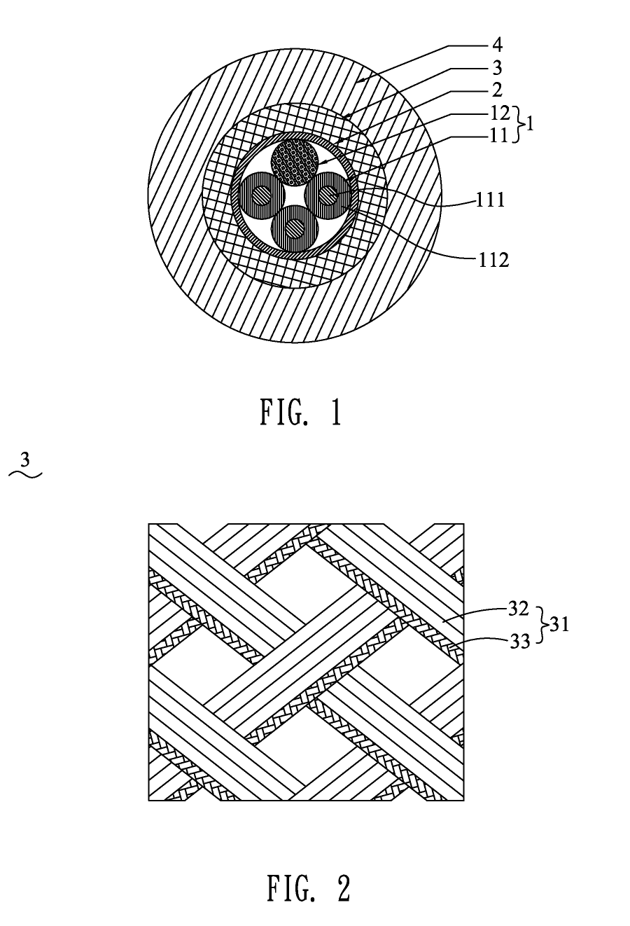

Please refer to FIGS. 1-2, a cable structure comprises a conductor 1, a shielding layer 2 wrapped the conductor 1, a knit layer 3 surrounding the shielding layer 2, and an insulating layer 4 bound round the knit layer 3. The conductor 1 has at least one conducting wire 11, and a fiber wire 12. In this embodiment, there are three conducting wires 11. The conducting wires 11 and the fiber wire 12 are entwined together. The fiber wire 12 is employed for enhancing the tensile strength of the conductor 1, reducing vibration and improving the fidelity. Each of the conducting wire 11 has a core wire 111 and an insulating cover 112 surrounding the core wire 111.

The knit layer 3 is interlaced by multiple knitting wires 31. Each of the knitting wires 31 has a plurality of metallic wires 32 and at least one fiber filament 33. The metallic wires 32 are arranged side by side to form a metal strip. Herein, the metal strip is composed of four metallic wires 32. The metallic wires 32 may be the tin-plated copper wires or the copper-plated aluminum wires. The at least one fiber filament 33 has an excellent performance of flexible deformation, and is disposed at an outer side of the metal strip. The fiber filament 33 may be the ballistic filament or the nylon filament. In knitting process, the abreast knitting wires 31 are arranged by the means of each two adjacent metallic strips sandwiching at least one fiber filament 33 therebetween, for reducing the extrusion and friction between the two adjacent metallic strips in use.

As described above, each of the knitting wires 31 has the fiber filament 33 which is capable of reducing the extrusion and friction between the two adjacent metallic strips when the cable structure is bent or twisted. Therefore, the knit layer 3 is able to bear the repeated bend and twist, correspondingly, elongating the use lifetime of the cable.

What is claimed is:

1. A cable structure, comprising:
a conductor;
a shielding layer wrapped the conductor;
a knit layer surrounding the shielding layer, the knit layer being interlaced by multiple knitting wires, each of the knitting wires having a plurality of metallic wires which are arranged side by side to form a metallic strip, and at least one fiber filament arranged at an outer side of the metallic strip; and
an insulating layer bound round the knit layer;
wherein the abreast knitting wires are arranged by means of each two adjacent metallic strips sandwiching at least one fiber filament therebetween.

2. The cable structure as claimed in claim 1, wherein the metallic wire is a tin-plated copper wire or a copper-plated aluminum wire.

3. The cable structure as claimed in claim 1, wherein the fiber filament is a ballistic filament or a nylon filament.

4. The cable structure as claimed in claim 1, wherein the conductor has at least one conducting wire and a fiber wire entwined together with the conducting wire.

5. The cable structure as claimed in claim 4, wherein the conducting wire has a core wire and an insulating cover surrounding the core wire.
